(19) United States
(12) Patent Application Publication
(10) Pub. No.: US 2026/0248060 A1
(43) Pub. Date: Aug. 27, 2026

(54) AGRICULTURAL ROBOTIC GANTRY SYSTEM HAVING A TOOL CARRIER ADAPTABLE TO A PLURALITY OF TOOLS

(71) Applicant: SYLVABOT, Saint-Nom-la-Bretèche (FR)

(72) Inventors: Alexia REY, Saint-Germain-en-Laye (FR); Olivier LE BLAINVAUX, Le Chesnay (FR); Norman ACOSTA, Mantes-la-Jolie (MX); Nicolas BALEYNAUD, Versailles (FR); Romuald CHIEUX, Chevreuse (FR); Mikaël ARGUEDAS, Clamart (FR)

(21) Appl. No.: 18/710,602

(22) PCT Filed: Nov. 9, 2022
(86) PCT No.: PCT/EP2022/081224

§ 371 Date: Mar. 31, 2026

(30) Foreign Application Priority Data
Nov. 15, 2021 (FR) FR2112079

(51) Int. Cl. A01B 51/02

(52) U.S. Cl. CPC A01B 51/023

(57) ABSTRACT

An agricultural robotic gantry system comprises at least one motorized carriage provided with a tool carrier for implementing a tool relative to a cultivation surface. The tool carrier has a coupling plate for coupling to the carriage and a tool carrier body. The tool jas a tool plate linked to a functional element of the tool. The tool carrier body and the tool plate are arranged to removably couple the tool to the tool carrier by a locking interface cooperating with a locking crosshead under the action of a slide configuration selector between an unlocked configuration and a locked configuration of the tool with the tool carrier.

### TECHNICAL FIELD

The invention relates to the technical field of agricultural robotic gantry systems. The invention aims in particular to provide a robotic gantry tool carrier for a market garden farm which adapts to several agricultural tools.

### BACKGROUND

U.S. Pat. No. 9,622,398 describes a robotic gantry comprising a gateway which is set in motion by propulsion means along a plurality of rows of crops, several agricultural tools coupled to the gateway, an electrical power supply system for the propulsion means, a controller which supervises the operation of the means of propulsion and agricultural implements, the controller activating an agricultural implement in response to the detection of predetermined environmental conditions. The patent also describes a method and computer system for controlling the operation of the robotic gantry.

Patent application AT 364659 describes a robotic gantry comprising a mobile bridge moving in the longitudinal direction by means of wheeled frames running on rails, a mobile cart moving in the transverse direction and designed as an equipment carrier (equipment for sowing or planting seeds or for weed control). The equipment carrier has a movable support in the vertical direction. An automatic control, implemented by computer, controls the movement of the bridge and the cart, as well as the operation of equipment for planting plants or sowing seeds and equipment for weeding.

Various disadvantages result from such robotic gantries, in particular with regard to the change of the agricultural tool in use by another agricultural tool, and the efficiency of implementation of the cultivation program which requires a specific agricultural tool to each type of intervention envisaged (soil preparation, sowing, planting, weeding, fight against unwanted pests, etc.). On the one hand, certain robotic gantry of the background art requires that each robotic gantry include all the tools, the ad hoc tool being activated according to the cultivation program, which makes the tool carrier complex, heavy, etc. On the other hand, certain robotic gantry of the background art requires the tool to be changed manually.

There is therefore a need to offer a robotic gantry system which makes tool changing easier to implement, for example by reducing or even avoiding the aforementioned disadvantages.

### SUMMARY

It is an object of the invention to propose a robotic gantry tool carrier for a market garden farm which overcomes one or more of the disadvantages or limitations of existing robotic gantry techniques.

According to one aspect, an agricultural robotic gantry system is proposed comprising at least one motorized carriage provided with a tool carrier for implementing a tool relative to a cultivation surface, the tool carrier comprising a coupling plate for coupling to the carriage and a tool carrier body, the tool comprising a tool plate linked to a functional element of the tool, the agricultural robotic gantry system is characterized in that the tool carrier body and the plate of the tool are arranged to removably couple the tool to the tool carrier and in that:
the tool carrier body comprises a body housing forming a cavity opening towards the tool plate, a locking crosshead positioned in the body housing and extending therein so as to be received in a sliding manner in translation by at least one bore of the body housing, the locking crosshead comprising a central part and at least one lateral part, said central part being dimensioned according to a first section of dimension smaller than a second section of said lateral part, and a slide configuration selector capable of translating the locking crosshead in the body housing and in the, at least one, bore of the body housing;
the tool plate comprises a locking interface provided with a groove defining at least one wall extending perpendicular to said tool plate and a bore of the locking interface positioned and dimensioned so that an opening made in the upper part of said wall only allows a passage of the central part and an opening made in the central part of said wall allows translation of the lateral part to form an open linear slide for said locking crosshead;
said locking interface cooperating with said locking crosshead under the action of said slide configuration selector between an unlocked configuration and a locked configuration of the tool with the tool carrier.

The body housing may comprise two facing bores, the locking crosshead comprising a central part and two lateral parts, the locking interface comprising two walls extending perpendicular to said plate of the tool each crossed by the bore of the locking interface, the locking crosshead being slidably received in translation in both bores of the body housing and in the bore of the locking interface.

The slide configuration selector can be made by means of a selector motor and an endless screw.

The tool carrier body may comprise several positioning holes for positioning the tool carrier with respect to the tool.

The tool carrier may comprise an identification sensor and the tool may include an identification tag.

The tool carrier may comprise an electrical and data connector for powering and/or exchanging data or commands between the tool carrier and the tool.

The system may further comprise a tool support comprising at least one support plate for supporting the tool fixed to a supporting structure and resting against a substantially vertical part of the supporting structure by means of at least one positioning bracket and at least one adjustment means for adjusting the horizontality of the support plate.

The adjustment means for adjusting the horizontality of the support plate may comprise an adjustment eccentric or an adjustment screw.

The tool carrier may comprise a set of tool carrier positioning sensors made in the form of a tool carrier positioning sensor assembly comprising a first tool carrier positioning sensor in the longitudinal direction, a second positioning sensor of the tool carrier in the transverse direction and a third positioning sensor of the tool carrier in the vertical direction, each sensor being made in the form of a mechanical linear position sensor.

The tool support may comprise a positioning trihedron for positioning the tool carrier relative to the tool on the tool support, said positioning trihedron comprising a first vertical part for longitudinal positioning, a second vertical part for transverse positioning and a horizontal part for height positioning cooperating respectively with said first, second and third positioning sensors of the tool carrier.

Alternatively, the tool carrier may comprise a means for positioning the tool carrier made in the form of at least one optical sensor for positioning the tool carrier, the tool support comprising at least one positioning target.

The tool plate may comprise at least one tool positioning hole, each tool positioning hole cooperating with a support positioning cone to position the tool on the tool support.

The invention is particularly applicable for robotic gantries ensuring varied interventions on the cultivation surface in order to improve the ability to change tools. The robotic gantry system according to the invention also has the following advantages:
It does not include a wheel or track moving directly on the ground, or installation of rails on the ground, making it possible to manage in a satisfactory manner problems of soil compaction;
The system does not require setting up complex infrastructures;
The system is structurally light, compact and easy to install, it is therefore particularly suitable for greenhouses of vegetable farms, a greenhouse which can include one or more chapels;
The system allows automated tool changing, resulting in a multitasking agricultural robot and increased productivity;
The tool locking interface is common to each tool and adapted to the tool carrier so that the tool carrier fits universally to any type of tool; and
The system allows automation of the most time-consuming, arduous and repetitive gardening tasks in order to concentrate the work of gardeners on tasks with higher added value.

Other advantages will emerge from the following description of the invention.

### BRIEF DESCRIPTION OF THE DRAWINGS

The present invention is illustrated by examples and not limited to the accompanying drawings, in which like references indicate similar elements:

FIG. 1 is a perspective view schematically representing a market garden micro-farm comprising a greenhouse comprising several chapels;

FIG. 2 is a schematic, semi-transparent top perspective view illustrating a greenhouse comprising several chapels, provided with a robotic gantry according to one embodiment of the invention;

FIG. 3 is a front view of a chapel shown in FIG. 2 schematically illustrating the robotic gantry system according to one embodiment of the invention;

FIG. 4 and FIG. 5 are schematic perspective views, respectively from above and below, of the tool carrier of the robotic gantry according to one embodiment of the invention;

FIG. 6 and FIG. 7 are schematic sectional views, respectively in perspective from above and from the front, of the tool carrier of the robotic gantry according to one embodiment of the invention showing the locking crosshead in an unlocked configuration;

FIG. 8 and FIG. 9 are schematic sectional views, respectively in perspective from above and from the front, of the tool carrier of the robotic gantry according to one embodiment of the invention showing the locking crosshead in a locked configuration;

FIG. 10 and FIG. 11 are schematic views, respectively in perspective from above and from the side, of the tool support of the robotic gantry according to one embodiment of the invention, a tool resting on said tool support; and

FIG. 12 is a perspective view schematically illustrating a tool carrier approaching the tool support on which a tool rests during operation of the robotic gantry according to one embodiment of the invention.

### DETAILED DESCRIPTION

The invention will be understood from the following description, in which reference is made to the appended drawings.

### Robotic Gantry in the Greenhouse

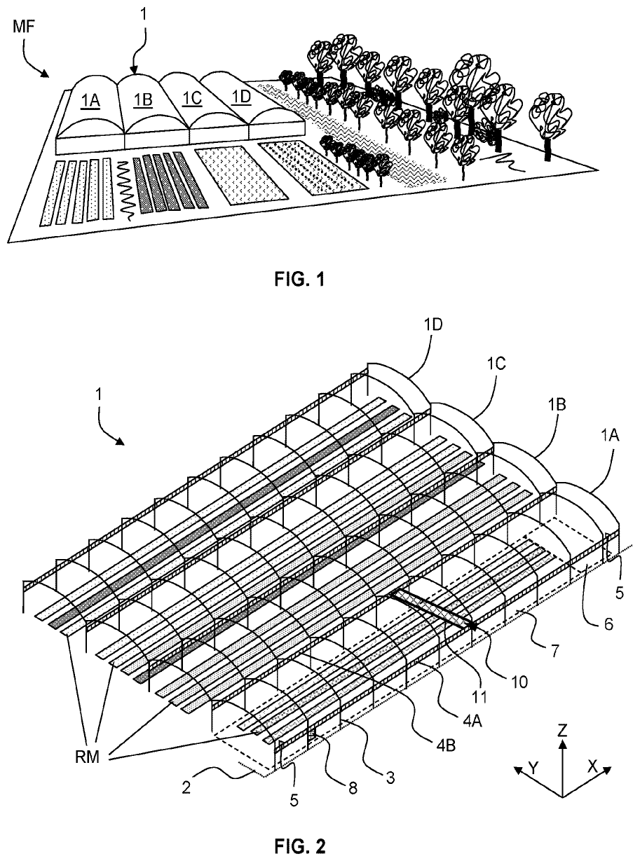

FIG. 1 schematically shows a market garden micro-farm MF in a perspective view. The market garden micro-farm MF includes for example at least one greenhouse 1 comprising several chapels, for example four adjacent chapels 1A, 1B, 1C and 1D.

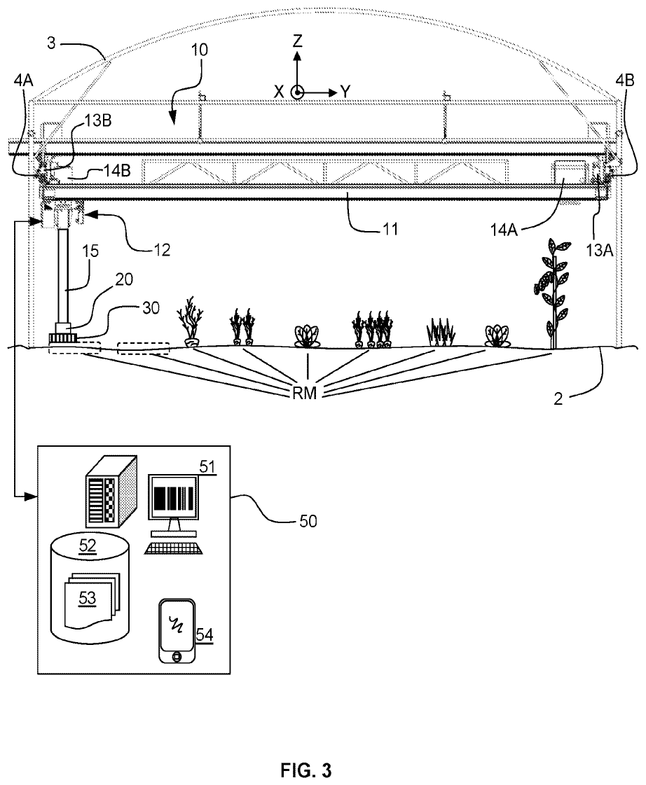

FIG. 2 schematically shows a greenhouse 1 comprising four adjacent chapels 1A, 1B, 1C and 1D in a semi-transparent top perspective view. Figure FIG. 3 is a front view of a first chapel 1A shown in FIG. 2 schematically showing the robotic gantry system 10. The first chapel 1A is made by a succession of arches 3 aligned in a longitudinal direction X, each arch being anchored appropriately in the ground 2. A cultivation surface RM, that is to say rows of vegetable crops extend on the ground 2 under the first chapel 1A in the longitudinal direction X in a cultivation area 7. Also, a tool storage area 6 is provided on floor 2 under the first chapel 1A. Although the FIG. 2 shows this tool storage area 6 at the end of the first chapel 1A, it could also be positioned elsewhere in the first chapel 1A, for example in the middle of the cultivation area 7, or elsewhere in the greenhouse 1, or elsewhere outside greenhouse 1. The first chapel 1A is equipped with a robotic gantry system 10. Rails 4A and 4B that are substantially horizontal and opposite each other are fixed on each of the two vertical uprights of the arches 3 at an appropriate height. A first carriage 11 can move along the rails 4A, 4B in the longitudinal direction X. The movement in the longitudinal direction X is carried out by a motorized assembly 13A powered and controlled by a first electrical box 14A. The first carriage 11 provides support and lateral guidance in the transverse direction Y of a second carriage 12. The second carriage 12 is provided with a tool carrier 20 for implementing a tool 30 relative to the cultivation surface RM, for example rows of vegetable crops. The cultivation tool 30 can be an agricultural tool of the passive type (i.e. essentially mechanical) or of the active type (i.e. which may include a motor and/or actuators and/or sensors). By way of non-limiting examples, the tool 30 can be a leveling tool, a plumb roller, a rake, a motor cultivator, a seeder, a weeding tool, a currycomb or disc harrow, a plant transplanter, a decompactor, a spreader, a plowing base, a planter, a device for treating undesirable weed, etc ... The second carriage 12 also includes a column 1 for moving the tool 30 in the vertical direction Z. The movements in the transverse Y and vertical directions Z are ensured by a second motorized assembly 13B powered and controlled by a second electrical box 14B. Stops 5 can be provided, for example at one or two rails 4A, 4B to prevent the robotic gantry 10 from moving beyond a predefined extreme position. A computer system 50 controls the operation of the robotic gantry 10, that is to say the movement of the carriages 11, 12, the choice of the tool 30 adapted to the agricultural intervention envisaged and the actuation of the tool 30. More precisely, the computer system 50 comprises a computer 51 provided with a memory 52 in which is stored software 53 for managing the market gardening farm activity, planning and daily monitoring of the activity of the exploitation of the market garden farm MF. The computer system 50 can also interact with a mobile device such as a computer tablet or multifunction mobile/smartphone 54. The computer system 50 can also receive various data (meteorology, temperature, air humidity, soil humidity, sunshine, soil condition, plant condition, etc.) from sensors 8 placed inside and outside of greenhouse 1. These data can be taken into account by the software 53.

The other chapels 1B, 1C and 1D can be designed similarly to the first chapel 1A.

Other greenhouses similar to the first greenhouse 1 can also be part of the market garden farm MF.

### Tool Carrier

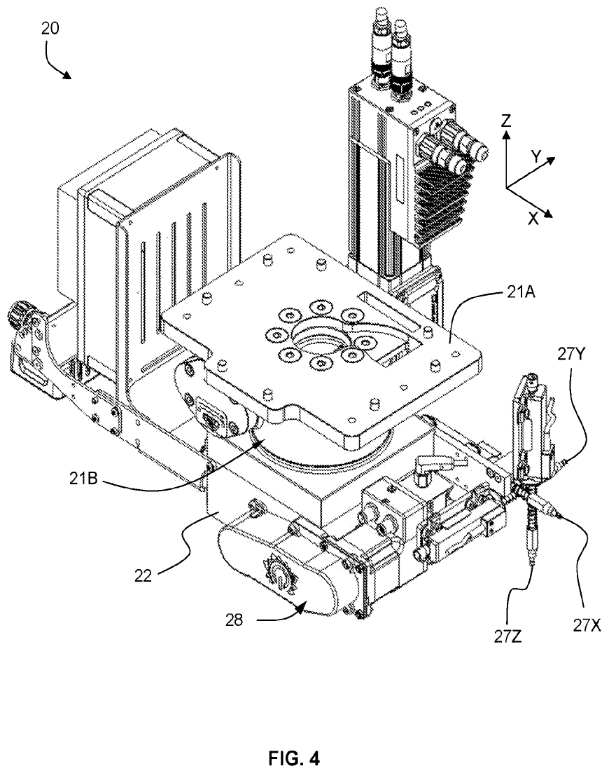

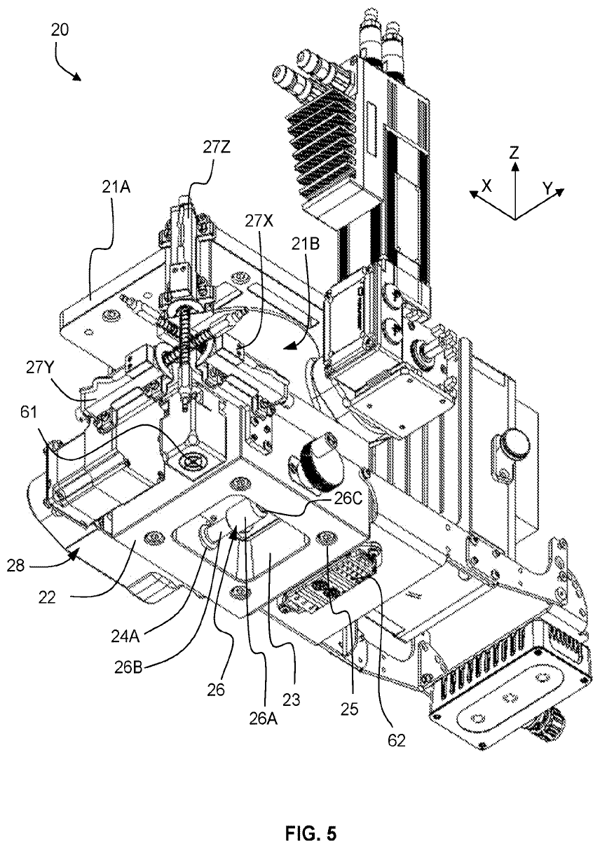

FIG. 4 and FIG. 5 show schematically in perspective from above and in perspective from below, a tool carrier 20 of the robotic gantry 10.

The tool carrier 20 mainly comprises a coupling plate 21A in the upper part, a tool carrier body 22 in the lower part and a set of tool carrier positioning sensors 27X, 27Y, 27Z.

The coupling plate 21A makes it possible to couple the tool carrier 20 to the column 15 of the second carriage 12. Appropriate coupling is achieved by positioning lugs and bores allowing bolting to the column (these elements and this coupling are not shown in detail in the Figures).

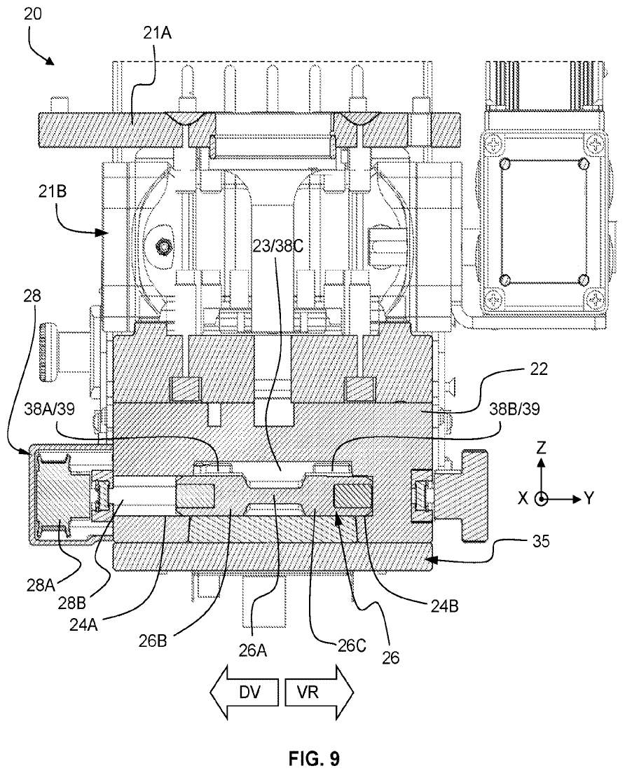

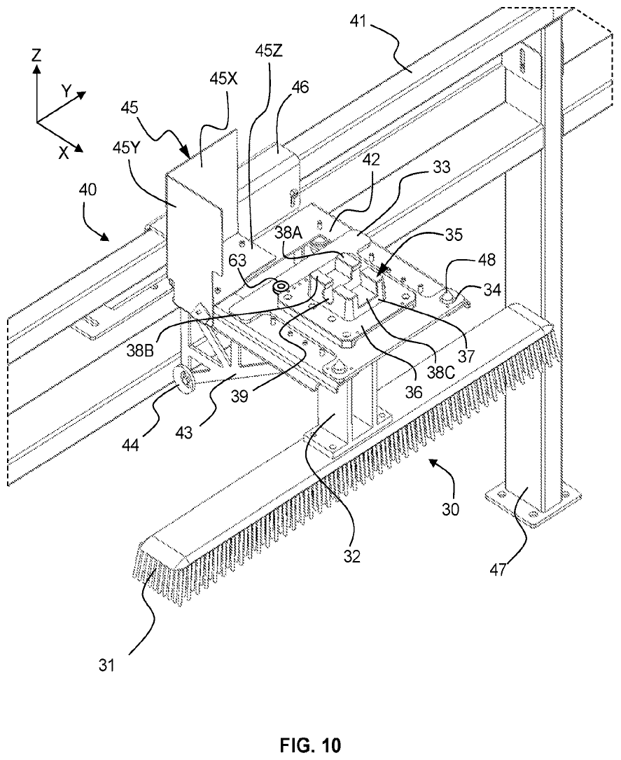

The tool carrier body 22 makes it possible to removably couple the tool 30 to the tool carrier 20. To do this, the tool carrier body 22 comprises a body housing 23 forming a cavity opening into the lower part of the tool carrier 20. The body housing 23 has two bores 24A, 24B facing each other. A locking crosshead 26 is positioned in the body housing 23 and extends therein so as to be slidably received in translation in the two bores 24A, 24B. The locking crosshead 26 comprises a central part 26A and two lateral parts 26B, 26C. The central part 26A is dimensioned according to a first section of smaller dimension than the second section of the two lateral parts 26B, 26C. The two lateral parts 26B, 26C may have a chamfer in the transition zone with the central part 26A. In the example presented, the bores 24A, 24B and the locking crosshead 26 extend and operate along the transverse axis Y. A crosshead configuration selector 28 is coupled to the tool carrier body 22, for example laterally. The crosshead configuration selector 28 allows the locking crosshead 26 to be positioned in either an unlocked configuration or a locked configuration by moving the locking crosshead 26 in the body housing 23 and in the two bores 24A, 24B. The crosshead configuration selector 28 can for example be made by means of a selector motor 28A and an endless screw 28B (see FIG. 9). The operation of the locking crosshead 26 in relation to the tool 30 will be explained hereinafter in more detail.

The tool carrier body 22 may include several positioning holes 25. The positioning holes 25 can be provided with a countersink. These positioning holes 25 can be used to fix the body of the tool carrier 22 to the upper part (coupling plate 21A and/or motorized crowns 21B). They can also be used to facilitate the correct positioning of the tool carrier 20 with respect to the tool 30.

The set of tool carrier positioning sensors comprises a first tool carrier positioning sensor in the longitudinal direction 27X, a second tool carrier positioning sensor in the transverse direction 27Y, and a third tool carrier positioning sensor in the vertical direction 27Z. Each of these sensors can be made in the form of a mechanical linear positioning sensor, for example a potentiometric displacement sensor comprising a sensor finger with a return spring and a measuring body with its connectors.

The tool carrier 20 may also include an identification sensor 61, for example an RFID sensor (i.e. “radio frequency identification”) to read the identity associated with a tool and identify the tool 30 in the zone of tool storage 6.

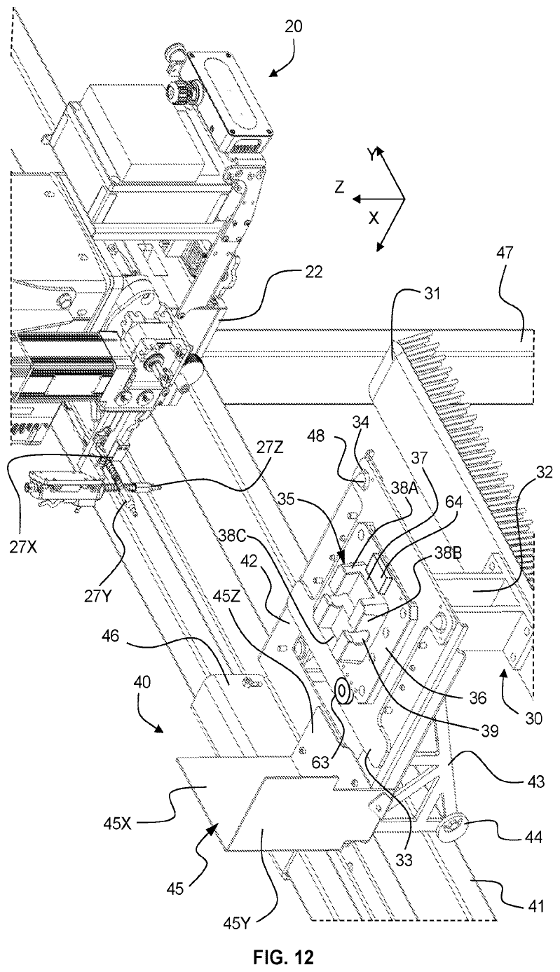

The tool carrier 20 may also include an electrical and data connector 62 to power and/or exchange data or commands where appropriate with a suitable tool (i.e. an active tool comprising integrated motors and/or actuators and/or sensors). In this case, the tool is equipped with a tool electrical and data connector 64 (visible in dotted lines in FIG. 12 for illustration purposes only of its position, the tool shown being passive).

The tool carrier 20 may also include a set of motorized crowns 21B arranged between the coupling plate 21A and the tool carrier body 22. This assembly, which will not be described in more detail herein, has the function of authorizing rotation in the horizontal plane (defined by the axes X and Y) thus making it possible to rotate the tool 30 if rendered necessary by the tool used (for example to correctly position a base blade relative to the vegetable row, to turn the tool in the right direction at the end of a row before starting a new row, etc.).

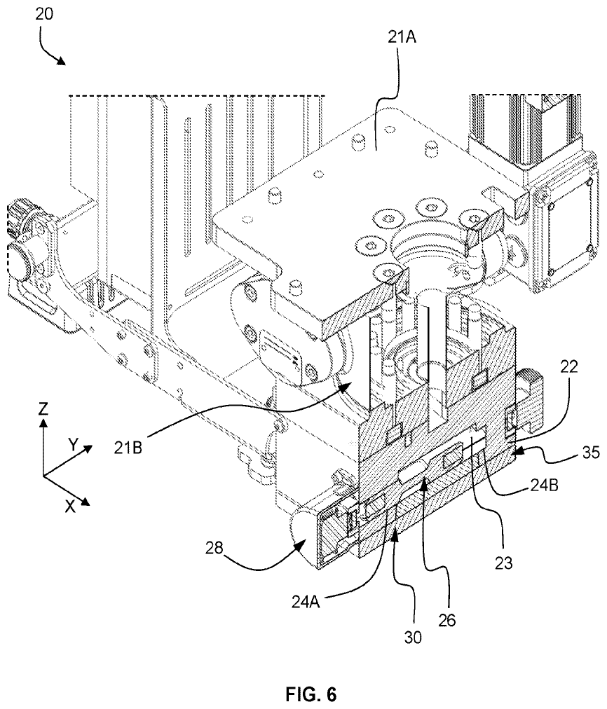

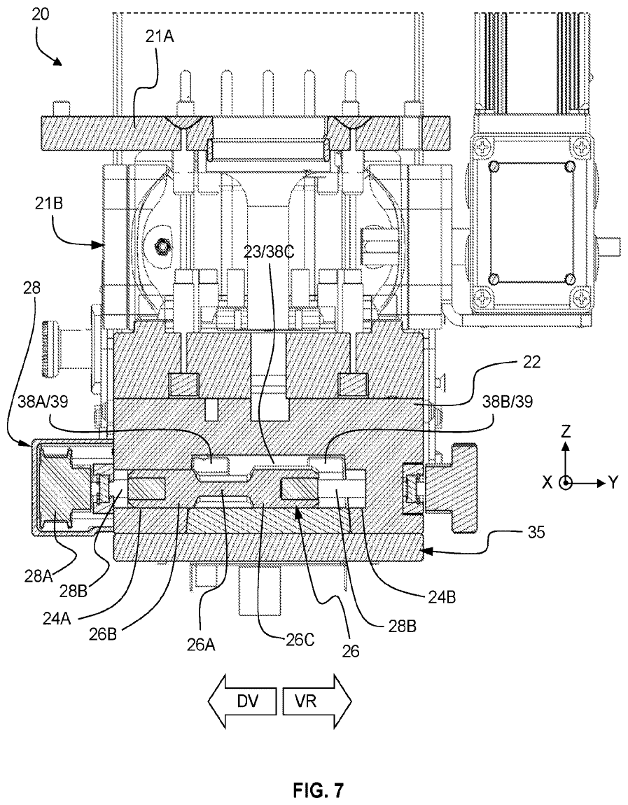

Figures FIG. 6 and FIG. 7 show schematically in cross-section, in perspective from above and from the front, a tool carrier 20 of the robotic gantry 10 illustrating the locking crosshead 26 being in an unlocked configuration. In this unlocked configuration, the first lateral part 26B of the locking crosshead 26 has moved almost completely in the first bore 24A under the action of the motor 28A and the endless screw 28B of the crosshead configuration selector 28. The thinned central part 26A of the locking crosshead 26 is then in a lateral position at the edge of the body housing 23 near the first bore 24A, leaving the second lateral part 26C of the locking crosshead 26 substantially in the center of the body housing 23.

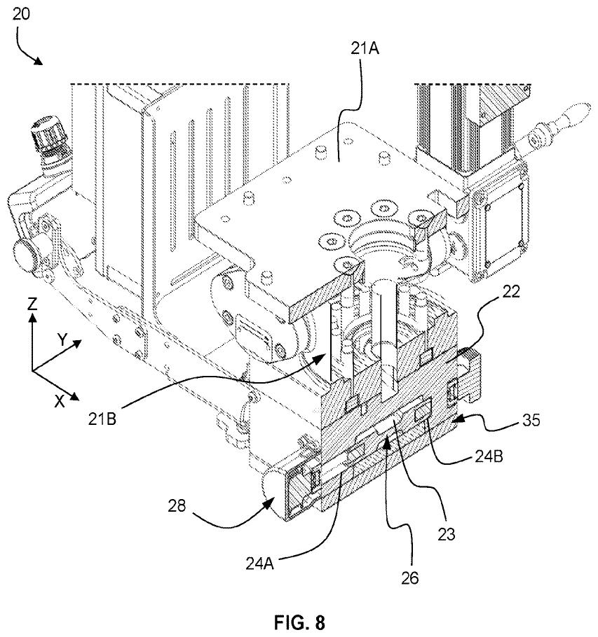

FIG. 8 and FIG. 9 show schematically in cross-section, in perspective from above and from the front, a tool carrier 20 of the robotic gantry 10 illustrating the locking crosshead 26 being in a locked configuration. In this locked configuration, following the action of the motor 28A and the endless screw 28B of the crosshead configuration selector 28, the thinned central part 26A of the locking crosshead 26 is in a centered position in the body housing 23, and the first and second lateral parts 26B, 26C of the locking crosshead 26 are in the body housing 23 in a position near the respective bores 24A, 24B and partially received by their ends in the respective bores. The central part 26A of the locking crosshead 26 is therefore located substantially in the center of the body housing 23, and the lateral parts 26B, 26C at the edge of the body housing 23.

### Tool on Tool Carrier:

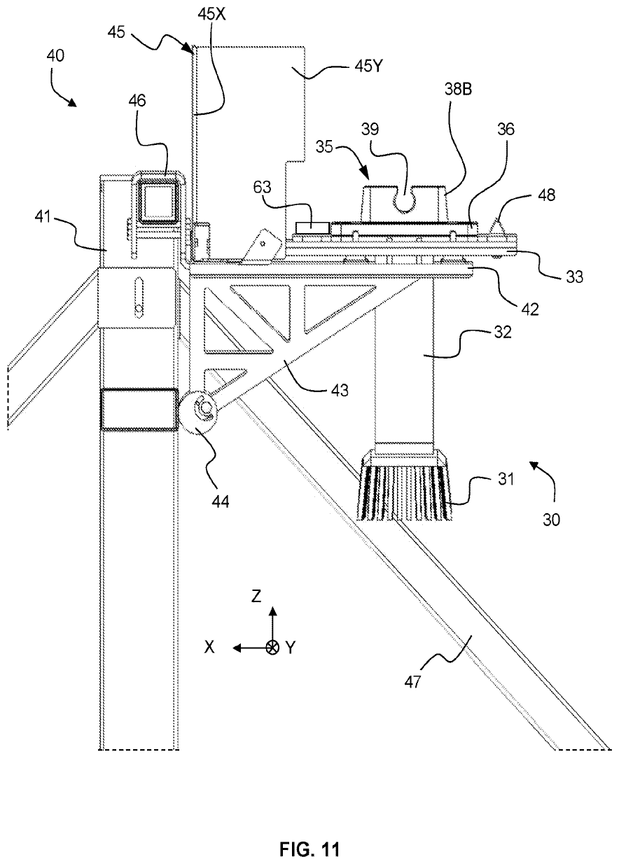

FIG. 10 and FIG. 11 show schematically in perspective from above and from the side, a tool support 40 of the robotic gantry and a tool 30 resting on the tool support 40.

The tool 30 comprises a functional element of the tool 31, a tool plate 33 and a connecting profile 32 of the functional element of the tool to the tool plate. The functional element of the tool 31 located in the lower part is intended to be in contact with the ground, the vegetables row or the plants. The tool plate 33 arranged in the upper part is intended to be placed on the tool support 40 and plays the role of interface with the tool carrier 20 to couple or uncouple the tool 30 to the tool carrier 20 of the robotic gantry system 10 depending on the market gardening action / farming operation envisaged. The tool 30 shown in the figures is a passive type tool, a sort of broom used to flatten soil that has already been worked, for example before sowing. Of course, this example is non-limiting and apart from the functional element of the tool 31, the other constituent parts of the tool 30, whatever its function, are analogous.

The tool plate 33 has tool positioning holes 34, for example two positioning holes 34. The positioning holes 34 cooperate with positioning cones of the support 48 to correctly position the tool 30 on the tool support 40. The plate of tool 33 may have a general H shape.

A locking interface 35 is fixed on the tool plate 33 and forms an open linear slide for the locking crosshead 26. The locking interface 35 comprises a base 36 on which there is a substantially parallelepiped part that is grooved and pierced comprising a sole 37, a groove 38C defining on either side a first wall 38A and a second wall 38B, and a bore 39. The sole 37 is a flat support surface extending parallel to the base 36. The groove 38C is substantially centered and extends in the longitudinal direction.

The first wall 38A and the second wall 38B are opposite each other and extend perpendicular to the sole 37, substantially in the vertical direction. The groove 38C, the first and second walls 38A, 38B define a long notch dimensioned to receive one or the other part of the locking crosshead 26. All of the first and second walls 38A, 38B and an upper part of the sole 37 are crossed from side to side by the bore 39.

The bore 39 opens into the upper part of the first and second walls 38A, 38B so that, on the one hand, the opening provided in the upper part is dimensioned to allow only the passage of the thinned central part 26A of the locking crosshead 26, and, on the other hand, the opening formed in the central part of the first and second walls 38A, 38B and partially in the upper part of the sole 37 is dimensioned to allow the translation of the central part 26A and the lateral parts 26B and 26C of the locking crosshead 26.

The tool 30, for example the plate of the tool 33, may also include an identification label 63, for example a radio tag of the RFID tool in order to identify the functional element of the tool 31 associated with the tool 30 located on the tool support 40.

The tool support 40 comprises a supporting structure 41 which may include several vertical or inclined holding posts 47. The tool support 40 includes one support plate 42 per tool 30. Even if the Figures show a single plate 42 and a single tool, the supporting structure 41 which is located in the tool storage area 6 may include a plurality of tools to form a tool rack. The support plate 42 may be fixed to the supporting structure 41 by a lateral positioning profile 46 of the tool support 40 on the supporting structure 41 allowing appropriate positioning depending on the dimension of the tool 30 in particular when several tools 30 are stored on the tool support 40.

The support plate 42 is positioned horizontally. This may be achieved by means of at least one positioning bracket 43 fixed under the plate and resting against a substantially vertical part of the supporting structure 41. At least one adjustment means, for example an adjustment eccentric 44, may be fixed on the positioning bracket 43 at the point of contact with the supporting structure 41 in order to precisely adjust the horizontality of the support plate 42, more particularly to guarantee that the support plate 42, the tool plate 33 and the tool carrier housing 22 are coplanar during coupling or uncoupling operations. With the adjustment eccentric 44, it is also possible to adapt the positioning of the support plate 42 to the deformations induced by the weight of each tool. As an alternative (not shown), the adjustment eccentric may be replaced by an adjustment screw fixed in the bracket and pushing on the supporting structure 41. The support plate 42 may have a general U-shape. It includes a positioning cone 48 of the support, for example at the ends of each branch of the U. These characteristics make it possible to support the tool 30, in particular the plate of the tool 33 in a well-defined manner in space in order to facilitate the coupling and uncoupling operations of the tool carrier 20 with the tool 30.

A positioning trihedron 45 of the tool carrier 20 relative to the tool 30 may also be attached on the support plate 42. It may be attached as close as possible to the supporting structure 41 so as not to interfere with the operations of the tool carrier 20. The positioning trihedron 45 comprises a first vertical part for longitudinal positioning 45X, a second vertical part for transverse positioning 45Y and a horizontal part for height positioning 45Z. The positioning trihedron 45 constitutes a spatial reference and cooperates with the positioning sensors 27X, 27Y, 27Z for the approach of the tool carrier 20.

### Locking/Unlocking on Support

FIG. 12 schematically illustrates in perspective a tool carrier 20 approaching a tool support 40 on which a tool 30 rests during operation of the robotic gantry system 11. Reference will also be made to FIG. 7 and FIG. 9 which show the coupling of the tool carrier 20 with the tool support 20.

During this approach phase, the tool carrier 20 is moved together with the first carriage 11, the second carriage 12 and the column 15 towards the tool support 40 located in the tool storage area 6. The locking crosshead 26 is in an unlocked configuration (see FIG. 7). The approximate position of each tool is stored in the memory 52 of the computer system 50. The software 53 for management of market gardening/farming activity, planning and daily monitoring of farm activity determines which tool must be used to carry out a particular action. Alternatively, the choice of tool can be done manually without necessarily using a command generated by the software. The fine approach is carried out by means of cooperation between the positioning sensors 27X, 27Y, 27Z and the positioning trihedron 45 of the tool carrier 20. First of all, the tool carrier 20 may be advanced in the direction of the longitudinal axis X until the first position sensor of the tool carrier in the longitudinal direction 27X comes into contact with the first vertical part 45X of the positioning trihedron 45. Then, the tool carrier 20 may be moved in the direction of the transverse axis Y until the second position sensor of the tool carrier in the transverse direction 27Y comes into contact with the second vertical part 45Y of the positioning trihedron 45. Finally, the tool carrier 20 may be lowered in the direction of the vertical axis Z until the third position sensor of the tool carrier in the vertical direction 27Z comes into contact with the horizontal part 45Z of the positioning trihedron 45. This approach phase is identical whether a tool is placed at the end of a market gardening/farming action, whether a tool is changed between two different market gardening/farming actions, or whether a tool is retrieved when the tool carrier is empty.

When the tool carrier finds itself empty and a new tool must be coupled to the tool carrier, after this approach phase, a coupling phase begins. When the tool carrier is lowered, at the end of the approach phase, the locking interface 35 of the tool 30 is inserted into the body housing 23. Since the locking crosshead 26 is in an unlocked configuration, on the one hand, the central part 26A fits into the bore 39 of the first wall 38A, on the other hand, the lateral part 26C fits into the groove 38C, and, finally, part of the endless screw 28B inserts into the bore 39 of the second wall 38B (see FIG. 7). Next, the selector motor 28A is controlled and drives the translation of the locking crosshead 26 in the locking interface 35 to position the locking crosshead 26 in a locked configuration (arrow VR). More precisely, the lateral part of the locking crosshead 26B is inserted into the bore 39 of the first wall 38A, the other lateral part of the slide 26C is inserted into the bore 39 of the second wall 38B, then the central part 26A finds itself in the groove 38C (see FIG. 9). Furthermore, the lateral part 26B remains partially received in the bore of the body housing 24A and the other lateral part 26C partially fits into the other bore 24B. The locking interface 35 is then locked in the body housing 23 via the locking crosshead 26 which crosses right through it.

The tool carrier 20 with the locked tool 30 may then be removed from the tool support 40 by rising along the vertical axis Z, then moving along the longitudinal axis X. Once this assembly has left the tool storage area 6, the robotic gantry 11 is moved to the cultivation area 7 to carry out the planned action.

When a tool 30 is coupled to the tool carrier 30 and this tool must be decoupled from the tool carrier, after the approach phase described above, a decoupling phase begins. The selector motor 28A is controlled and drives the translation of the locking crosshead 26 in the locking interface 35 to position the locking crosshead 26 in an unlocked configuration (arrow DV). More precisely, during this translation, the central part of the locking crosshead 26A is inserted into the bore 39 of the first wall 38A, the lateral part of the locking crosshead 26B is extracted from the bore 39 of the first wall 38A and penetrates further forward into the bore of the body housing 24A, the other lateral part of the slide 26C is extracted from the bore 24B and the bore 39 of the second wall 38B and is inserted into the groove 38C (see FIG. 7). The locking interface 35 is then free to move in the vertical direction Z in the body housing 23, being no longer locked by the locking crosshead 26. When the tool carrier is raised, the locking interface 35 of the tool 30 can then freely exit the body housing 23.

The tool carrier 20 being no longer locked with the tool 30, the tool carrier 20 may then be removed and moved away from the tool support 40 on which the tool 30 rests in place by rising along the vertical axis Z. Once this operation is completed, the tool-free assembly may be either directed by appropriate translations along the longitudinal axis X and the transverse axis Y towards another tool stored on another plate of the supporting structure or be moved empty outside the tool storage area 6. The drawings and their description above illustrate rather than limit the invention. It should be noted that, even if the embodiment of the present invention has been illustrated for use in a greenhouse comprising several chapels, it is also suitable for use in a greenhouse with a single chapel or even in several greenhouses. It can also be used for use outside a greenhouse provided that the area to be cultivated would be equipped with posts supporting rails allowing the robotic gantry to move. In addition, the crosshead configuration selector produced by means of a selector motor and an endless screw is not limiting because other means of moving the locking crosshead are possible, for example a translation of the locking crosshead could be obtained by magnetic or pneumatic means. In addition, the electrical and data connector which has been described and represented is not limiting, the tool carrier may also include a fluid connector (air, water, treatment product, etc.). Also, the tool carrier as presented and described is not essential to the operation of locking/unlocking a tool to the tool carrier whose locking interface can also operate independently, the tool carrier being only a means to position in a defined manner the tools awaiting use. It is possible to replace the support described by a simple support guaranteeing a certain horizontality of the tool plate and means of communication between the tool carrier and the tool to determine its exact position in the greenhouse. Also again, with regard to the relative positioning of the tool carrier with the tool support, the example of sensors produced in the form of mechanical linear position sensors cooperating with a positioning trihedron is not limiting, because other positioning means are possible such as for example optical sensors (for example at least one camera) capable of determining the position of the tool carrier by cooperating with a positioning target placed on the tool support or even the tool itself. Furthermore, the identification of the functional element of the tool by the cooperation of the RFID type identification sensor with the RFID radio tag of the tool is only an example, any other means of identification is possible, for example a camera cooperating with a code of the bar code or QR (“quick response code”) code type. Finally, the locking interface made in the form of a substantially parallelepiped piece grooved and pierced is not limiting since it could also be in the form of a cylinder or a prism or any other polyhedron to the extent where the body housing has a suitable shape.

### LIST OF REFERENCES

1 greenhouse
RM Cultivation surface
1A, 1B, 1C, 1D Chapel
2 Floor
3 Arch
4A, 4B Guide rail along the longitudinal axis direction X
5 Stop
6 Tool storage area
7 Cultivation area
8 Sensors
10 Robotic gantry
11 First Carriage (X direction)
12 Second Carriage (Y+Z direction)
X Longitudinal axis
Y Transverse axis
Z Vertical axis
13A, 13B Motorized assembly
14A, 14B Electrical box
15 Column/Arm
20 Tool carrier
21A Coupling plate
21B Motorized crown assembly
22 Tool carrier body
23 Body housing
24A, 24B bore of the body housing
25 Positioning hole with countersink
26 Locking crosshead
26A central part of the locking crosshead
26B, 26C lateral parts of the locking crosshead
27X, 27Y, 27Z Tool carrier positioning sensor/sensor finger/return spring
28 Crosshead configuration selector
28A Selector motor
28B Endless screw
61 Identification sensor
62 Electrical and data connector
30 Tool
31 Functional element of the tool
32 Profile for connecting the functional element of the tool to the tool plate
33 Tool plate
34 Tool positioning hole
35 Locking interface
36 Base
37 Sole
38A, 38B, 38C First and second walls, groove
39 Bore of the locking interface
63 Tool identification label
64 Electrical and data connector of the tool
40 Tool support
41 Supporting structure
42 Support plate
43 Plate positioning bracket
44 Adjustment means (eccentric adjustment)
45 Positioning trihedron for positioning the tool carrier relative to the tool
45X Vertical part for longitudinal positioning
45Y Vertical part for transverse positioning
45Z Horizontal part for height positioning
46 Lateral positioning profile of the tool support on the structure
47 Holding posts
48 Support positioning cone
50 Computer system
51 Computer
52 Memory
53 Software
54 Smartphone/Tablet

1. An agricultural robotic gantry system comprising at least one motorized carriage provided with a tool carrier for implementing a tool relative to a cultivation surface the tool carrier comprisingcomprises:
a coupling plate for coupling to the carriage and a tool carrier body, the tool comprising a tool plate linked to a functional element of the tool; the agricultural robotic gantry system thatwherein the tool carrier body and the tool plate are arranged to removably couple the tool to the tool carrier and in that wherein:
the tool carrier body comprises a body housing forming a cavity opening towards the tool plate a locking crosshead positioned in the body housing and extending therein so as to be received in a sliding manner in translation by at least one bore of the body housing the locking crosshead comprising a central part and at least one lateral part said central part being dimensioned according to a first section of dimension smaller than a second section of said lateral part, and a slide configuration selector capable of translating the locking crosshead in the body housing and in the, at least one, bore of the body housing ;
the tool plate comprises a locking interface provided with a groove defining at least one wall extending perpendicular to said tool plate and a bore of the locking interface positioned and dimensioned so that an opening made in the upper part of said wall only allows a passage of the central part and an opening made in the central part of said wall allows a translation of the lateral part to form an open linear slide for said locking crosshead ; and
said locking interface cooperating with said locking crosshead under the action of said slide configuration selector between an unlocked configuration and a locked configuration of the tool with the tool carrier

2. The system of claim 1, wherein the body housing comprise two facing bores the locking crosshead comprising a central part and two lateral parts the locking interface comprising two walls extending perpendicular to said plate of the tool each crossed by the bore of the locking interface the locking crosshead being slidably received in translation in both bores of the body housing and in the bore of the locking interface.

3. The system according to claim 1, wherein the slide configuration selector is made by means of a selector motor and an endless screw.

4. The system according to claim 1, wherein the tool carrier body includes several positioning holes for positioning the tool carrier with respect to the tool.

5. The system according to claim 1, wherein the tool carrier includes an identification sensor and the tool includes an identification tag.

6. The system according to claim 1, wherein the tool carrier comprises an electrical and data connector for powering and/or exchanging data or commands between the tool carrier and the tool.

7. The system according to claim 1, further comprising a tool support comprising at least one support plate for supporting the tool fixed to a supporting structure and resting against a substantially vertical part of the supporting structure by means of at least one positioning bracket and at least one adjustment means for adjusting the horizontality of the support plate

8. The system of claim 7, wherein the adjustment means for adjusting the horizontality of the support plate comprises an adjustment eccentric or an adjustment screw.

9. The system according to claim 7, wherein the tool carrier comprises a set of tool carrier positioning sensors made in the form of a tool carrier positioning sensor assembly comprising a first tool carrier positioning sensor in the longitudinal direction a second positioning sensor of the tool carrier in the transverse direction and a third positioning sensor of the tool carrier in the vertical direction, each sensor being made in the form of a mechanical linear position sensor.

10. The system of claim 9, wherein the tool support comprises a positioning trihedron for positioning the tool carrier relative to the tool on the tool support said positioning trihedron comprising a first vertical part for longitudinal positioning a second vertical part for transverse positioning and a horizontal part for height positioning cooperating respectively with said first, second and third positioning sensors of the tool carrier.

11. The system according to claim 7, wherein the tool carrier comprises a means for positioning the tool carrier made in the form of at least one optical sensor for positioning the tool carrier, the tool support comprising at least one positioning target.

12. The system according to claim 7, wherein the tool plate comprises at least one tool positioning hole each tool positioning hole cooperating with a support positioning cone to position the tool on the tool support.
